(19) United States
(12) Patent Application Publication
(10) Pub. No.: US 2016/0120736 A1
(43) Pub. Date: May 5, 2016

(54) MALE-ORIENTED SEX PARAPHERNALIA WITH REMOVABLE MODULES

(71) Applicant: Wai Kin Yeung, Hong Kong (HK)

(72) Inventor: Wai Kin Yeung, Hong Kong (HK)

(21) Appl. No.: 14/919,736

(22) Filed: Oct. 22, 2015

(30) Foreign Application Priority Data
Nov. 5, 2014 (CN) 201410617416.8

(51) Int. Cl. A61H 19/00; A61H 23/00

(52) U.S. Cl. CPC A61H 19/32; A61H 23/00

(57) ABSTRACT

A sex paraphernalia comprising a hollow tubular body configured to receive a human part therein and a plurality of removable modules physically and functionally removably coupled to the inner surface of the hollow tubular body is disclosed. The removable modules are movable over the inner surface independently. The sex paraphernalia further comprises an audio input port and an audio analyzer which determines the intensity and frequency of the audio signal received by the audio input port and generates a control signal based on the same to control the motion of the removable modules.

### FIELD OF INVENTION

The present invention relates to a male oriented sex paraphernalia and in particular to a male oriented sex paraphernalia with removable functional modules.

### BACKGROUND OF INVENTION

The sex paraphernalia market is huge and ever expanding. In past few years, related businesses in US are estimated to gross more than USD 15 billion annual sales. Despite the enormous market potential, most of the sex paraphernalia available nowadays are female-oriented and, no doubt that, the need of male are greatly overlooked.

### SUMMARY OF INVENTION

In the light of the foregoing background, it is an object of the present invention to provide a male-oriented sex paraphernalia, in particular a male-oriented sex paraphernalia with removable modules.

Accordingly, the invention comprises an apparatus embodying features of construction, combinations of elements and arrangement of parts that are adapted to affect such steps, all is exemplified in the following detailed disclosure, and the scope of the invention will be indicated in the claims.

According to one aspect, the present invention is a sex paraphernalia including a hollow tubular body configured to receive a human part therein; and a plurality of removable modules physically and functionally removably coupled to the inner surface of the hollow tubular body. The removable modules are movable over the inner surface independently.

According to a specific embodiment of the present invention, the sex paraphernalia further includes a motion control module coupled to the plurality of removable modules; wherein the motion control module is configured to control rotational motions and translational motions of the removable modules.

According to another embodiment of the present invention, the sex paraphernalia further including: an audio input port disposed at the outer surface of the hollow tubular body and configured to receive an input audio signal; an audio analyzer coupled to the audio port and configured to determine at least one characteristic of the input audio signal; and a motion controller coupled to the audio analyzer and the removable modules. The motion controller is further configured to control motion of the removable modules based on the characteristic of the input audio signal.

### BRIEF DESCRIPTION OF THE DRAWINGS

For a more complete understanding of the present invention, reference is made to the following detailed description and accompanying drawings, in which:

FIG. 1 is a schematic diagram of the male-oriented sex paraphernalia according to a specific embodiment of the present invention;

FIG. 2 is a bottom view of the male-oriented sex paraphernalia according to a specific embodiment of the present invention;

FIG. 3 is a cross-sectional view of the male-oriented sex paraphernalia according to a specific embodiment of the present invention;

FIG. 4 is a schematic diagram of the male-oriented sex paraphernalia during the replacement of the removable modules according to the embodiment as shown in FIG. 3; and

FIG. 5 shows different removable modules configured to be connected to the male-oriented sex paraphernalia according to a specific embodiment of the present invention.

### DETAILED DESCRIPTION OF THE PREFERRED EMBODIMENTS

As used herein and in the claims, “comprising” means including the following elements but not excluding others.

As used herein and in the claims, “couple” or “connect” refers to electrical coupling or connection either directly or indirectly via one or more electrical means unless otherwise stated.

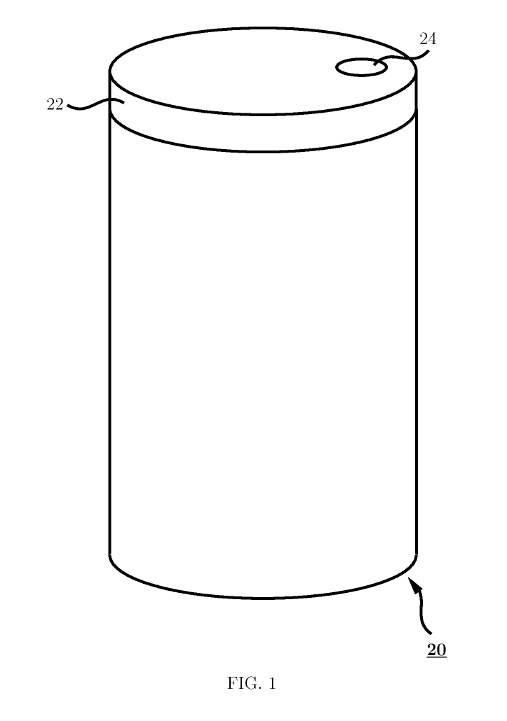

Referring to FIG. 1, a male-oriented sex paraphernalia 20, according to one embodiment of the present invention, is a cylindrical tube. The male-oriented sex paraphernalia 20 includes a separable upper portion 22, which further includes a audio input port 24. The male-oriented sex paraphernalia 20 further includes an audio analyzer (not shown) to analysis the audio signal received by the audio input port 24. In one embodiment, the audio analyzer is configured to analyse the amplitude, intensity and frequency of the audio signal.

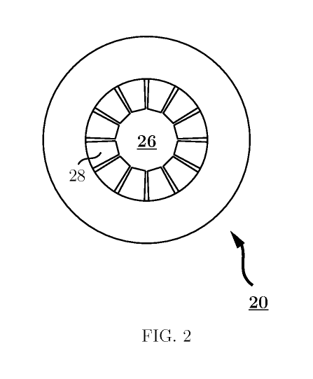

The bottom view of the male-oriented sex paraphernalia 20 is shown in FIG. 2. The bottom of the male-oriented sex paraphernalia 20 includes a opening 26 which is configured to accept the male sex organ. At the inner edge of the opening 26, there are a plurality of protruding teeth 28 extending inwardly towards the opening 26. In this embodiment, the protruding teeth 28 is made of soft materials, for instance silicon. As such, when a male sex organ is inserted into the male-oriented sex paraphernalia 20, the protruding teeth 28 will be deform to fit the outer geometry of the male sex organ to provide a suitable fit therefore.

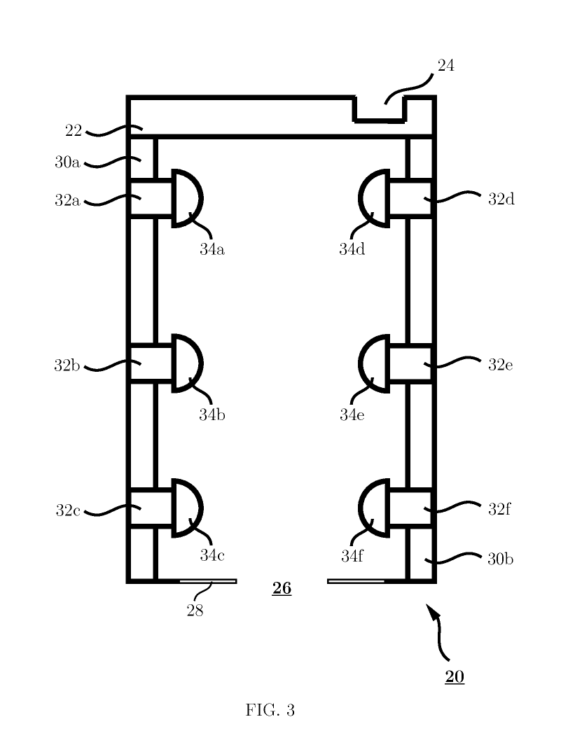

Referring now to FIG. 3, a cross-sectional view of the male-oriented sex paraphernalia 20 is shown. As shown in FIG. 3, the male-oriented sex paraphernalia 20 includes two tracks 30a and 30b extended from the upper portion 22 of the male-oriented sex paraphernalia 20 to the end with opening 26. There are some fasteners 32a-32f disposed on the tracks 30a and 30b. Each of the fasteners 32 is coupled with one removable module 34 and further includes a motion control module (not shown). In one embodiment of the present invention, the motion control module controls the translational motions of the removable modules 34 along their corresponding track 30 and the rotational motions of the removable modules 34 along the axis of their corresponding fastener 32. In one embodiment, the motion control module is further configured to control the vibration of the removable modules 34. In another embodiment, the motion control modules are connected with the audio analyzer of the male-oriented sex paraphernalia 20. The audio analyzer generates control signal to the motion control modules according to the amplitude, intensity and frequency of the audio signal as received by the audio input port 24. As such, the amplitude and the frequency of the aforesaid motions are correlated with the amplitude, intensity and frequency of the audio signal as received by the audio input port 24 so as to provide an all-rounded sensation to the user. For instance, the functional modules will rotate and move faster when a higher frequency audio is detected.

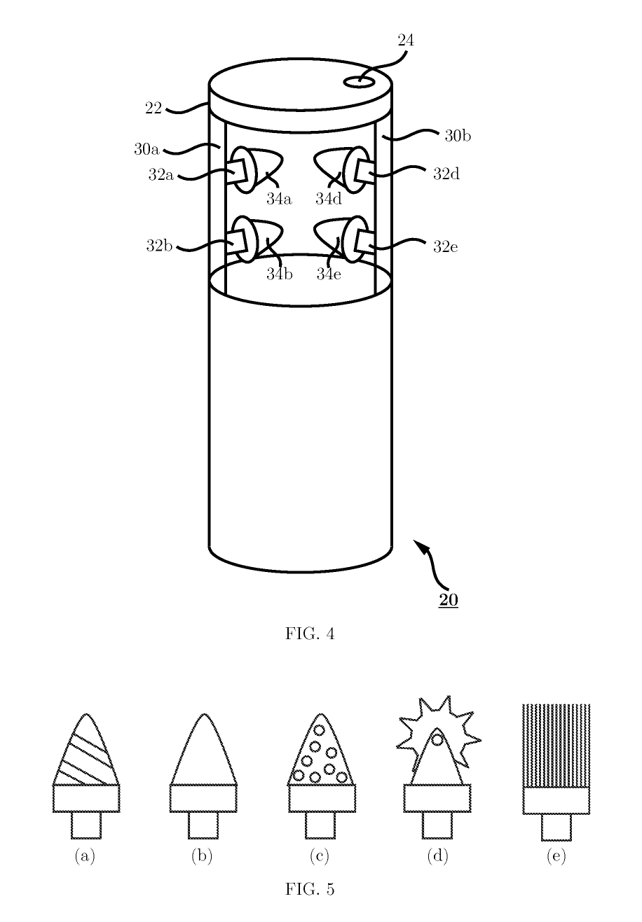

In order to facilitate the attachment of the removable module 34 and customization process of the inner surface of the male-oriented sex paraphernalia 20, the upper portion 22 of the male-oriented sex paraphernalia 20 is detachable from the main body of the male-oriented sex paraphernalia 20 as shown in FIG. 4. The tracks 30a and 30b are fixedly attached to the upper portion 22 of the male-oriented sex paraphernalia 20. When the user wish to clean the male-oriented sex paraphernalia 20 or to change the removable module 34 so as to customize the internal surface of the male-oriented sex paraphernalia 20, the user can pull out the upper portion 22 of the male-oriented sex paraphernalia 20 and separate the upper portion 22 from the main body of the male-oriented sex paraphernalia 20. Such configuration enables easy cleaning and customization of the male-oriented sex paraphernalia 20.

It will thus be seen that the objects set forth above, among those elucidated in, or made apparent from, the preceding description, are efficiently attained and, since certain changes may be made in the above construction and/or method without departing from the scope of the invention, it is intended that all matter contained in the above description or shown in the accompanying drawing figures shall be interpreted as illustrative only and not in a limiting sense.

For instance, the removable module 34 as described in the above embodiments are cone shape. However removable modules with other shapes and functions, as shown in FIG. 5, could also be used. FIG. 5(a) to FIG. 5(c) shows a type naming drill bit like silicon head. These heads are rotatable along the axial axis when attached to the sex paraphernalia. The outer surface can have different pattern so as to provide different level of sensation. FIG. 5(d) shows a gear like silicon head, of which the head will rotate like a gear when the user move the sex paraphernalia during use. FIG. 5(e) shows a furry head which can be made of a plurality of materials, for instance rubber, string or hair.

Furthermore, the male-oriented sex paraphernalia 20 as described in the aforesaid embodiments includes two tracks 30a and 30b and three fasteners 32 on each track 30. However, it should be obvious to one skilled in the art that any number of tracks and fasteners could be adopted in the male-oriented sex paraphernalia 20. Moreover, the shape of the male-oriented sex paraphernalia 20 should not be limited to a cylindrical shape. The same can be designed into any shapes and sizes according to the users' preferences.

The following claims should not be read as limited to the described order or elements unless stated to that effect. Therefore, all statements of the scope of the invention which, as a matter of language, might be said to fall therebetween.

What is claimed:

1. A sex paraphernalia, comprising:
a) a hollow tubular body configured to receive a human part therein; and
b) a plurality of removable modules physically and functionally removably coupled to the inner surface of said hollow tubular body;
wherein said removable modules are movable over said inner surface independently.

2. The sex paraphernalia of claim 1 further comprising:
a) a plurality of tracks disposed within said inner surface of said hollow tubular body along the axial direction of said hollow tubular body; and
b) a plurality of fasteners coupled to said tracks and configured to move independently along said axial direction;
wherein said removable modules are physically and functionally removably coupled to said fasteners.

3. The sex paraphernalia of claim 1 further comprising a motion control module coupled to said plurality of removable modules; wherein said motion control module is configured to control rotational motions and translational motions of said removable modules.

4. The sex paraphernalia of claim 3 further comprising:
a) an audio input port disposed at the outer surface of said hollow tubular body and configured to receive an input audio signal;
b) an audio analyzer coupled to said audio port and configured to determine at least one characteristic of said input audio signal; and
c) a motion controller coupled to said audio analyzer and said removable modules;
wherein said motion controller is further configured to control motion of said removable modules based on said characteristic of said input audio signal.

5. The sex paraphernalia of claim 4 further comprises a vibration controller coupled to said audio analyzer and said removable modules; wherein said vibration controller is configured to control vibration of said removable modules based on said characteristic of said input audio signal.

6. The sex paraphernalia of claim 4, wherein said at least one characteristic comprises amplitude, intensity, frequency and combination thereof.
